(19) United States
(12) Patent Application Publication
(10) Pub. No.: US 2012/0018261 A1
(43) Pub. Date: Jan. 26, 2012

(54) FIXING STRUCTURE OF AUXILIARY BRAKING DEVICE FOR UTILITY VEHICLE

(75) Inventors: Byoung Soo KWON, Changnyeong-gun (KR); Dai Seung SON, Changnyeong-gun (KR)

(73) Assignees: HANKUK CHAIN INDUSTRIAL CO., LTD., Anseong-si (KR); DAEDONG INDUSTRIAL CO., LTD., Daegu (KR)

(21) Appl. No.: 13/187,668

(22) Filed: Jul. 21, 2011

(30) Foreign Application Priority Data
Jul. 23, 2010 (KR) 10-2010-0071233

(51) Int. Cl. B60T 1/06; B60T 7/08; F16D 55/2255

(52) U.S. Cl. 188/72.9

(57) ABSTRACT

A fixing structure of an auxiliary braking device for a utility vehicle is provided, which includes a brake disc mounted on a driving shaft at which an output of a transmission is received; a brake pad mounted at a vehicle body in such a manner as to compress the brake disc by the cooperative operation with the manipulation of a brake lever mounted at a driver seat and to perform a braking operation; and a spline coupling part mounted at one end of the driving shaft in such a manner as to be fixedly coupled to a rear axle input shaft of a rear wheel differential gear so as to have the restriction in the axial movement thereof.

### CROSS-REFERENCE TO RELATED APPLICATION

This application claims priority to and the benefit of Korean Patent Application No. 10-2010-0071233, filed on Jul. 23, 2010, the disclosure of which is incorporated herein by reference in its entirety.

### BACKGROUND OF THE INVENTION

1. Field of the Invention

The present invention relates to a utility vehicle with an auxiliary braking device mounted on a driving shaft like a propeller shaft, and more particularly, to a fixing structure of an auxiliary braking device for a utility vehicle wherein a brake disc is mounted along a driving shaft at a position corresponding to a brake pad of the auxiliary braking device in such a manner as to be rotated in a state of being fixed in axial displacement thereof, thereby preventing the mutual interference between the brake pad and the brake disc from occurring at the time of releasing a braking operation.

2. Background of the Related Art

Generally, utility vehicles have the purposes of delivering objects or persons in working environments like off-roads wherein general vehicles are hard to move.

FIG. 1 is a schematic view showing a conventional utility vehicle, and FIG. 2 is an enlarged view showing a portion ‘A’ of FIG. 1. As shown in the drawings, the conventional utility vehicle has a structure wherein a driver seat 10 and a load box 20 are opened to the outside, and the driver seat 10 is surrounded with a rollover prevention frame 30 adapted to protect a driver from the danger caused when the vehicle is overturned.

The rollover prevention frame 30 is supportedly coupled to a main frame of the utility vehicle.

Further, the conventional utility vehicle has an engine room 60 mounted in a space under the load box 20 at the back of the driver seat 10 and a radiator room 70 mounted in a space at the front of the driver seat 10.

Also, the conventional utility vehicle includes a braking device having a foot brake and a parking brake mounted thereon.

The foot brake is used as a main braking device of a vehicle, which is pedaled during driving to decelerate or stop the vehicle.

The parking brake is used as an auxiliary braking device, which serves to brake wheels in a state where the vehicle stops so as to restrict the movement of the vehicle parked or stopped. The parking brake is called a hand brake or a side brake.

FIGS. 1 and 2 show an example wherein a parking brake lever 80 is mounted on a left side of the driver seat 10.

Generally, when the vehicle is parked or stopped, a driver pulls the parking brake lever 80, to set a braking state, and then, he leaves the vehicle. For driving, after that, he releases the pulling state of the parking brake lever 80.

The parking brake lever 80 is operated to manipulate a brake pad (not shown) mounted at the underside of a vehicle body and to allow a brake disc (not shown) rotated unitarily by the cooperative operation with a shaft to be compressed against the brake pad, thereby achieving a braking operation.

According to the auxiliary braking device of the conventional utility vehicle, however, the brake pad is fixedly mounted on the vehicle body, and the relative position of the brake disc to the brake pad is moved by the cooperative operation with the displacement of the shaft, such that even though the braking state of the parking brake lever 80 is released, the mutual interference between the brake pad and the brake disc occurs to cause abnormal abrasion therebetween.

According to the auxiliary braking device of the conventional utility vehicle, moreover, upon the design of the shaft, a spline coupling part is mounted to have given displacement in a power transmission section, thereby preventing a power transmission system from being destructed by the driving impacts and engine vibrations, which unavoidably causes the mutual interference between the brake pad and the brake disc, thereby reducing the life span of the auxiliary braking device through the abnormal abrasion of the brake pad and the brake disc and causing the friction noise therebetween.

### SUMMARY OF THE INVENTION

Accordingly, the present invention has been made in view of the above-mentioned problems occurring in the prior art, and it is an object of the present invention to provide a fixing structure of an auxiliary braking device for a utility vehicle wherein a brake disc is mounted along a driving shaft at a position corresponding to a brake pad of the auxiliary braking device in such a manner as to be rotated in a state of being fixed in axial displacement thereof, thereby preventing the mutual interference between the brake pad and the brake disc from occurring at the time of releasing a braking operation.

To accomplish the above object, according to the present invention, there is provided a fixing structure of an auxiliary braking device for a utility vehicle including: a brake disc mounted on a driving shaft at which an output of a transmission is received; a brake pad mounted at a vehicle body in such a manner as to compress the brake disc by the cooperative operation with the manipulation of a brake lever mounted at a driver seat and to perform a braking operation; and a spline coupling part mounted at one end of the driving shaft in such a manner as to be fixedly coupled to a rear axle input shaft of a rear wheel differential gear so as to have the restriction in the axial movement thereof.

According to the present invention, desirably, the spline coupling part mounted at one end of the driving shaft is fixedly coupled to the rear axle input shaft of the rear wheel differential gear by means of the penetration of a fixing pin therebetween.

According to the present invention, desirably, the driving shaft is a propeller shaft.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a schematic view showing a conventional utility vehicle;

FIG. 2 is an enlarged view showing a portion ‘A’ of FIG. 1;

FIG. 3 is a perspective view showing a power transmission system in a utility vehicle according to the present invention;

FIG. 4 is a front view showing the power transmission system in the utility vehicle according to the present invention;

FIG. 5 is a schematic view showing a structure of supporting an engine and a transmission in the utility vehicle according to the present invention; and

FIG. 6 is an exploded perspective view showing a structure of installing a driving shaft of an auxiliary braking device in the utility vehicle according to the present invention.

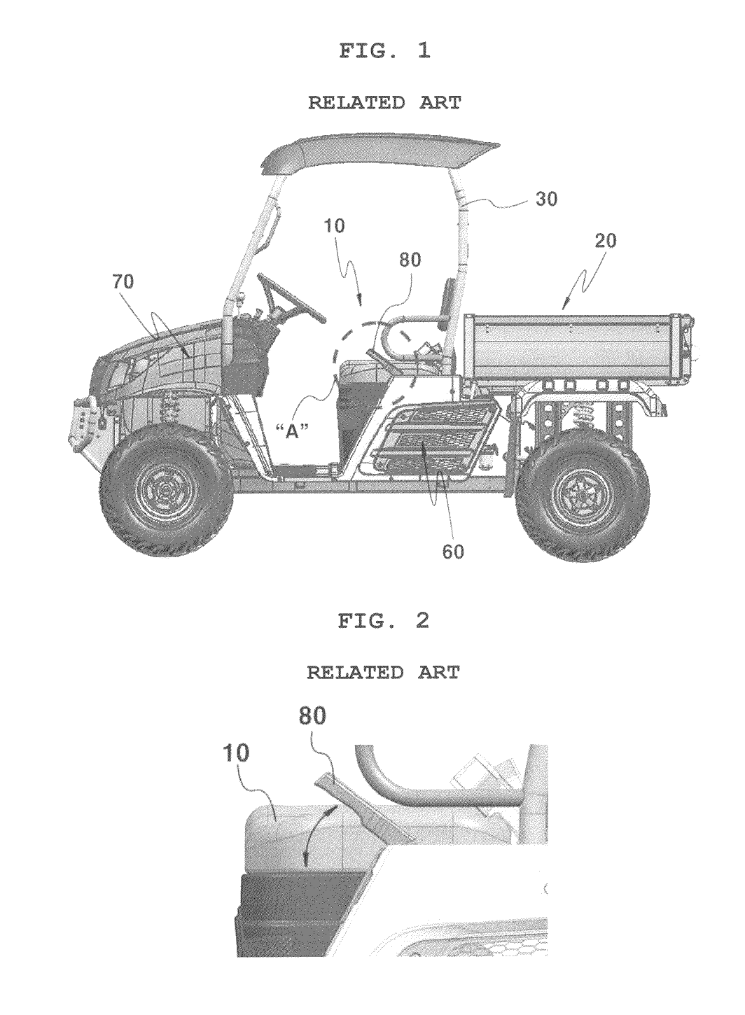

### DETAILED DESCRIPTION OF THE PREFERRED EMBODIMENT

Hereinafter, an explanation on a fixing structure of an auxiliary braking device for a utility vehicle according to the present invention will be in detail given with reference to the attached drawing.

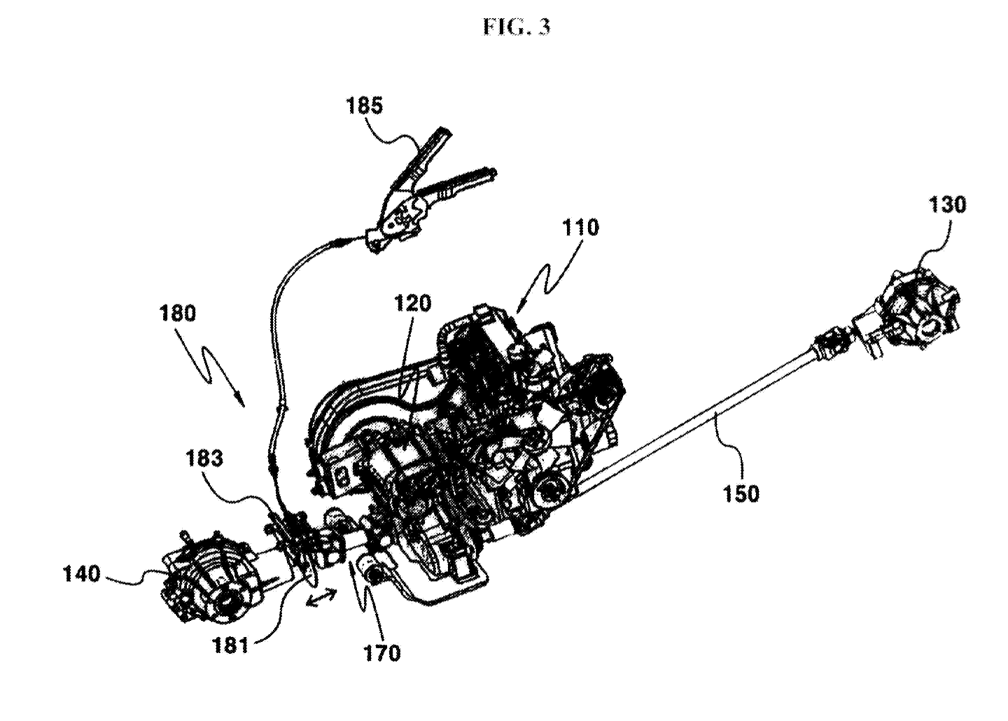

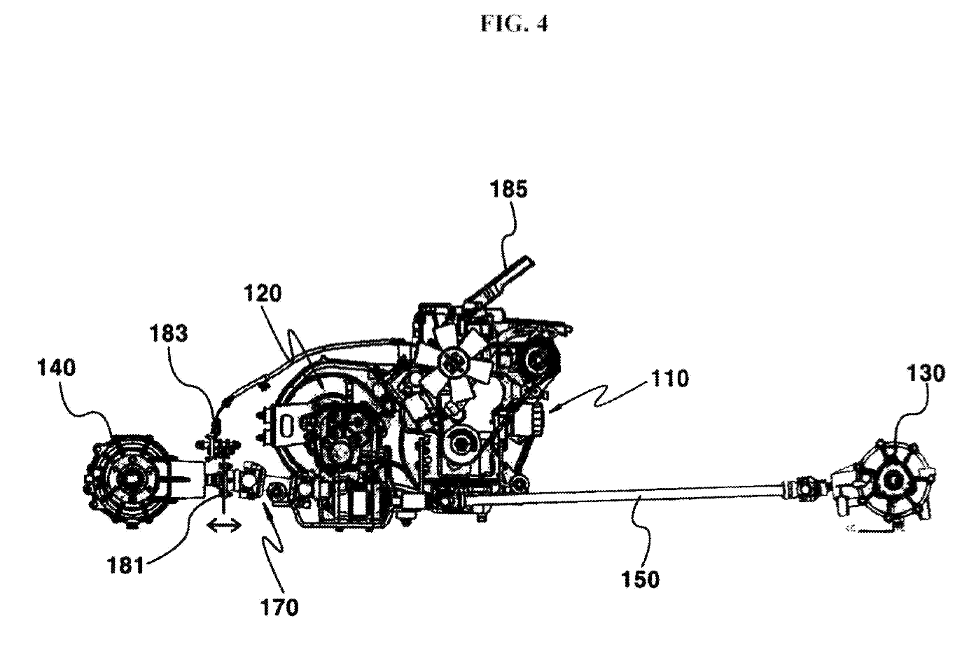

Referring to FIGS. 3 to 6, an explanation on a power transmission system of a utility vehicle according to the present invention will be given.

According to the present invention, power is generated from an engine 110, and the generated power is inputted to a transmission 120 in which gear shifting is performed in accordance with reduction gear ratios.

At this time, the power transformed through the transmission 120 is outputted via transmission output shafts 121 and 123.

The transmission output shafts 121 and 123 are adopted for a four-wheel drive type vehicle wherein power is outputted at the same time to both directions of the transmission 120, that is, to front and rear directions of the vehicle, or are adopted for a two-wheel drive type vehicle wherein power is outputted only to one of the front and rear directions of the vehicle.

According to the present invention as shown in FIGS. 3 to 6, the four-wheel drive type vehicle is adopted.

In this case, the power outputted through the transmission output shafts 121 and 123 is sent to a front wheel differential gear 130 and a rear wheel differential gear 140 via a first driving shaft 150 and a second driving shaft 170.

The first driving shaft 150 and the second driving shaft 170 are used as a power transmission member well known as a propeller shaft. The propeller shaft is composed of a multi joint portion having two or more hinge shafts, such that the shaft is bent in a non-linear section to perform power transmission and is gently bent in a section wherein displacement is seriously generated by vibrations to perform power transmission.

At this time, the connected portions among the first driving shaft 150, the transmission output shaft 123 and the front wheel differential gear 130 are spline-coupled to one another and are thus displaced in the direction of the length thereof.

According to the present invention, a brake disc 181 of an auxiliary braking device 180 is mounted along the second driving shaft 170.

The brake disc 181 is coupled to the second driving shaft 170 and is rotated together with the second driving shaft 170 to which the rotary power of the transmission 120 is received.

Further, a brake pad 183 is coupled to a vehicle body (not shown) so as to compress the brake disc 181 thereagainst and to perform a braking operation.

The brake pad 183 is connected to a cable cooperatively operated with the manipulating force of a parking brake lever 185 as shown in FIG. 3.

That is, the manipulating force of the parking brake lever 185 is sent to the brake pad 183 through the cable, and the brake pad 183 compresses the brake disc 181 from both directions thereof at the same time to restrict the rotation of the second driving shaft 170.

The above-mentioned auxiliary braking device 180 is used at the time of parking or stopping the vehicle in the state where driving stops.

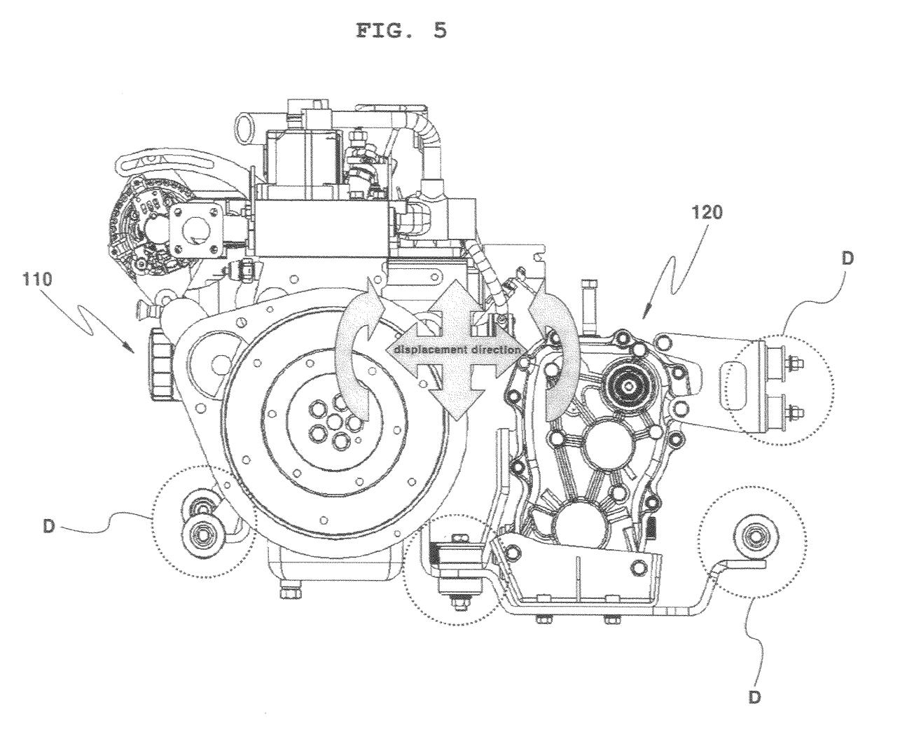

FIG. 5 shows the driving state of the vehicle, and in this case, the positions of the engine 110 and the transmission 120 are moved in top, bottom, left and right directions, such that the displacement is performed in the directions of lengths of the second driving shaft 170 and the first driving shaft 150 power-connected to the transmission output shafts 121 and 123.

As shown in FIG. 5, the engine 110 and the transmission 120 according to the present invention are fixedly mounted on the vehicle body by means of vibration dampeners D, and thus, the vibration of the engine 110 itself and the vibration of the vehicle body during driving are absorbed through the vibration dampeners D. In this case, the first driving shaft 150 connected to the transmission output shaft 123 of the transmission 120 and the second driving shaft 170 connected to the transmission output shaft 121 of the transmission 120 are displaced.

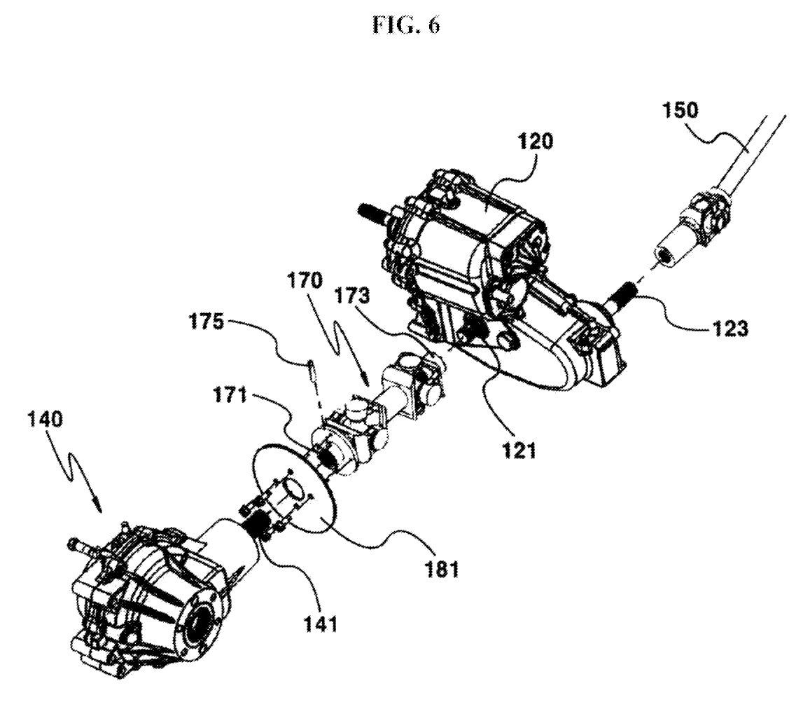

Referring to FIG. 6, hereinafter, an explanation on a structure wherein the second driving shaft 170 has the restriction in the cooperative operation with the vibrations of the engine 110 and the transmission 120 will be given.

As shown, the second driving shaft 170 is the propeller shaft and is connected at one end thereof to the transmission output shaft 121 by means of a spline coupling part 173 and connected at the other end thereof to a rear axle input shaft 141 by means of a spline coupling part 171.

According to the present invention, at this time, the spline coupling part 171 is fixedly coupled to the rear axle input shaft 141 by means of the penetration of a fixing pin 175 therebetween. As a result, the spline coupling part 171 of the second driving shaft 170 is formed unitarily with the rear axle input shaft 141, and the other end of the second driving shaft 170 is coupled to the rear wheel differential gear 140 fixed to the vehicle body, thereby restricting the axial displacement.

The brake disc 181 is coupled along the outer periphery of the spline coupling part 171 of the second driving shaft 170, thereby restricting the axial displacement, and the position corresponding to the brake disc 181, that is, the relative position to the brake pad 183 fixed to the vehicle body is maintained constantly, thereby preventing the mutual interference therebetween from occurring.

At this time, the spline coupling part 173 disposed on one end of the second driving shaft 170 and the transmission output shaft 121 are not fixed to each other, thereby maintaining the state of being displaced in the axial direction thereof, such that the displacements caused by the vibrations of the engine 110 and the vehicle body during driving are offset to prevent the impacts caused between the second driving shaft 170 and the transmission 120 and between the second driving shaft 170 and the rear wheel differential gear 140.

According to the present invention, under the above-mentioned structure, when the auxiliary braking device 180 is mounted, the brake pad 183 is coupled to the vehicle body, and the brake disc 181 positioned correspondingly to the brake pad 183 is coupled along the second driving shaft 170. At this time, the spline coupling part 171 disposed on one end of the second driving shaft 170 is fixedly coupled constrainedly to the rear axle input shaft 141 of the rear wheel differential gear 140, such that the relative displacement between the brake pad 183 and the brake disc 181 is restricted to prevent the generation of the relative friction caused by the mutual interference therebetween at the time of releasing the braking operation.

As described above, there is provided the fixing structure of the auxiliary braking device for the utility vehicle wherein the brake pad is coupled to the vehicle body, and the brake disc is coupled along the second driving shaft, thereby restricting the relative displacement between the brake pad and the brake disc to prevent the generation of the relative friction at the time of releasing the braking operation.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A fixing structure of an auxiliary braking device for a utility vehicle comprising:
a brake disc mounted on a driving shaft at which an output of a transmission is received;
a brake pad mounted at a vehicle body in such a manner as to compress the brake disc by the cooperative operation with the manipulation of a brake lever mounted at a driver seat and to perform a braking operation; and
a spline coupling part mounted at one end of the driving shaft in such a manner as to be fixedly coupled to a rear axle input shaft of a rear wheel differential gear so as to have the restriction in the axial movement thereof.

2. The fixing structure of an auxiliary braking device for a utility vehicle according to claim 1, wherein the spline coupling part mounted at one end of the driving shaft is fixedly coupled to the rear axle input shaft of the rear wheel differential gear by means of the penetration of a fixing pin therebetween.

3. The fixing structure of an auxiliary braking device for a utility vehicle according to claim 1, wherein the driving shaft is a propeller shaft.
